(19) United States
(12) Patent Application Publication
(10) Pub. No.: US 2013/0206641 A1
(43) Pub. Date: Aug. 15, 2013

(54) HAIR COLORING FORMULA IDENTIFICATION CLIP DEVICE, SYSTEM, AND METHOD

(71) Applicant: Kimberly Sue Newton, Fredericksburg, VA (US)

(72) Inventor: Kimberly Sue Newton, Fredericksburg, VA (US)

(21) Appl. No.: 13/658,806

(22) Filed: Oct. 23, 2012

Related U.S. Application Data
(63) Continuation-in-part of application No. 12/588,663, filed on Oct. 22, 2009, now abandoned.

(51) Int. Cl. A45D 44/00; G09F 3/16

(52) U.S. Cl. CPC A45D 44/00; G09F 3/16
USPC 206/581; 40/647

(57) ABSTRACT

A specifically contoured smooth, hard plastic, dark colored hair coloring formula identification clip device, a system of its use, and a method of steps to track and achieve a desired outcome. The hair coloring identification clip preferably includes a stain and water resistant, peel and stick, replaceable, wet erase writing surface label portion.

### FIELD OF THE INVENTION

The present invention is directed to a hair coloring formula identification clip device, a hair coloring identification system, and method of utilizing the identification hair coloring chemical formulas.

### BACKGROUND OF THE INVENTION

Before deciding which tools to use, the hair care professional will assess the hair type, current condition and previous chemical processing and desired outcome.

The hair care professional utilizes multiple tools to perform their duties. Currently, a hair colorist will mix up multiple types, levels, volumes and brands of formulas of hair coloring or other chemicals to apply to a person's hair during a hair coloring application or treatment. The different formulas are applied at different stages or steps of the process, to different areas of the hair, to achieve a desired outcome.

Most used is the multipurpose standard mixing bowl to hold and access a product. The hair colorist uses the bowls for mixing and containing different formulas of hair coloring for application to the person's hair. These bowls typically are not marked to identify the particular formula or its placement in each bowl. Thus, it is very common that the wrong formula, and its placement, is applied during the coloring process causing poor outcomes. For this reason, the colorist will note on one side of the multiple clips the various formulas for the different colors and note the placement of each formulation on the opposite side of the corresponding clip. This is done in most cases because chemicals process differently at the root of the hair than the ends of the hair.

Thus, it is desirable to provide an identification device, system, and method of positively marking bowls containing the different hair color formulas and placement of each for the purpose of the hair colorist identifying the proper formula and placement so there is no mix up of the formulas while mixing and the placement thereof when correctly applying the different hair coloring formulation on the required area of the hair. For example, as many as four or five bowls are used in one color application process, and proper identification of the different hair formulas and placement are important at each stage.

Finally, the formula and placement can be recorded in client records for future reference and reuse on the same client. Then the stain and water resistant, peel and stick, replaceable, wet erase writing surface label is wiped clean and ready for reuse.

### SUMMARY OF THE INVENTION

A first object of the present invention is to provide a hair coloring identification clip device specifically designed to be attachable to a standard mixing bowl, so the formula and placement are visible while mixing and applying the chemicals which make up the system, and method of its use.

A second object of the present invention is to provide a hair coloring identification clip device that is smooth hard plastic, dark colored and specifically contoured to fit any standard mixing bowl.

A third object of the present invention is to provide a hair coloring identification clip device including a markable and erasable writing surface portions to be used with a wet erase pen.

A fourth object of the present invention is to provide a hair coloring identification clip device including an laminated, peel and stick writing label portion.

A fifth object of the present invention is to provide a hair coloring identification clip device that will be able to withstand continuous use. Making the device convenient, reusable and eco friendly.

A sixth object of the present invention is to provide a hair coloring identification system of uses to professionally perform a hair care process including at least one hair coloring identification clip device.

A seventh object of the present invention is to provide a hair coloring identification system that will allow the professional to record and maintain each formulation and its placement, along with identifying the individual client (by name) anytime during or after its use, for future reference and reuse particularly at times when multiple clients are being serviced simultaneously—which is often.

A eighth object of the present invention is to provide a hair coloring identification method, including the steps of marking containers of different hair coloring formula and placement to allow identification of the hair coloring formulas before, during and after use, the levels of color and developer contained therein the location of its placement on the hair as well.

Although this device can be used in many different arenas, the present invention is directed to a hair coloring identification clip, system, and method. The hard plastic, dark colored, water & stain resistant hair coloring identification clip according to the present invention includes a wet erase markable or writable portion. This configuration allows a hair colorist to mark or write on the label of hair coloring identification clip. For example, the hair colorist can write the particular formula and its placement of the hair coloring chemical mixture on one or both sides of the hair coloring identification clip device, and then clip the hair coloring formula identification clip device to the salon standard mixing container containing that particular formula. The marking or writing by the hair colorist on the hair color identification clip device can be permanent (e.g. reuse of same clip device with same hair coloring formula at a future date), or more preferably erasable to allow reuse (e.g. reuse of same clip device with a different hair coloring formula at a future date after information is recorded on client card). The erasable embodiment allows for more versatility and type of reuse (e.g. less clip devices are required due to erasability feature thereby being eco friendly).

In a preferred embodiment, the hair coloring identification clip was designed specifically to include a first clip portion, and a second clip portion with a contoured opening to grip onto the standard mixing bowl, a specifically positioned spring connecting the clip portions together and for biasing gripping ends of the clipped portions together to provide a clip device. For example, a metal coiled spring includes bent end portions for attaching the two (2) clip portions together to make an assembled clip device.

The surface of the clip portions (e.g. one side or both sides) are made with a space large enough for a label to be markable, writable and erasable before, during, and/or after use. For example, the surface can be painted, coated, textured or labeled to allow a hair colorist to mark and/or write thereon. The mark or writing, for example, can indicate the hair coloring formulas and the placement of each formulation. The written on clip device is then attached to a container (e.g. mixing bowl) containing that particular hair coloring formula to mark the contents of that container and the placement of the formula. The professional would use a wet erase marker to write the hair coloring formula and its placement. Alternatively, a label, sticker or other separately marked indicator can be attached to one or both sides of the clip device to indicate the hair coloring formula or the hair coloring formula itself and the placement of the formula on the opposite side.

In one preferred embodiment, a wooden clip is painted with a textured coating that accepts writing thereon. Depending on the particular coating, the writing can be erasable to allow reuse of the clip device. In another embodiment, only a portion of the clip device is textured to allow writing only on the textured portion.

In another preferred embodiment, one or more separate surfaces or laminates having a markable or writable surface can be applied to one or both clip portions of the clip device, for example, by using adhesive, sticky back, heat welding, plastic insert injection molding, mechanical fastening, or other suitable technique to attach the surface or laminate to the clip portion(s).

The clip device can have a uniform width, or can be made so as to have a wider writing surface area to provide more room for writing on the label portion. The label portion can be made integral with the clip device, or can be a separate part or component attached thereto.

The hair coloring identification system includes multiple hair coloring identification clips for multiple containers (e.g. mixing bowls). The hair coloring identification clips are made so as to be removably attach to an upper edge of the mixing bowls. Preferably, the hair coloring identification clips attached to the bowls in a manner so as to not come into contact with the hair coloring formula itself.

According to the present invention, the hair coloring identification method includes writing the hair coloring formula on one side and placement on the other of a hair coloring identification clip device, attaching the same to the container or mixing bowl and then combining the colors and developer and placing a particular hair coloring formula into a container (e.g. mixing bowl). In this manner, the particular hair coloring formula contained in the container or bowl and the placement thereof, are marked so as to be later identified with the correct hair coloring formula and placement when being applied to a person's hair. When using multiple different hair coloring formulation for different areas of the hair on the same person during application, in this manner the proper hair coloring formula and their placement are identified prior to application to the each person. Also identifying the individual client, by name, is necessary when attending multiple clients simultaneously, which is often.

### BRIEF DESCRIPTION OF THE DRAWINGS

FIG. 1 is a perspective view of a hair color identification clip device according to the present invention.

FIG. 2 is a side elevational view of a hair color identification clip device shown in FIG. 1.

FIG. 3 is a front elevational view of another embodiment of a hair color identification clip device.

FIG. 4 is a side elevational view of the hair color formula identification clip shown in FIG. 4.

FIG. 5 is a front elevational view of a further embodiment of the hair identification clip device according to the present invention.

FIG. 6 is a front elevational view of another further embodiment of the hair color identification clip device according to the present invention emphasizing the label portion.

FIG. 7 is a perspective view of an embodiment of a hair color identification clip system according to the present invention clipped onto a mixing bowl.

### DETAILED DESCRIPTION OF PREFERRED EMBODIMENTS

A preferred embodiment of the hair coloring identification clip device according to the present invention is shown in FIGS. 1 and 2.

The identification clip includes a first clip portion 12 and a second clip portion 14 with a coiled metal spring 16 connecting the clip portions 12, 14 together. The spring 16 includes a bent gripping portion 16a, 16b for fastening the clip portions 12, 14 together. For example, the spring 16 can be a coiled metal spring designed to apply opposite torque to the clip portions 12, 14 so as to bias the gripping end 12a, 14a of the clip portion 12, 14 together.

The clip portions 12, 14 can be made of wood, and then coated (e.g. paint) with a surface that can be marked or preferably written thereon. Further, the coated surface can be selected to not only be markable or writable, but also erasable to allow reuse of the clip device 10 (e.g. with other hair coloring formulas). Alternatively, the clip portions 12, 14 can be made of plastic (e.g. plastic injection molded) and provided with a surface finish that allows writing and/or erasing (e.g. textured finish). A textured finish can be provided by sand blasting, shot penning, bead penning, machining, or other suitable technique applied to desired surfaces of the mold used for plastic injection molding of the clip portions 12, 14.

Another embodiment of the hair coloring identification clip device 20 according to the present invention is shown in FIG. 3.

The hair coloring identification clip device 20 includes a regular surface portion 20a and a extured surface portion 20b selected to allow marking or writing, and preferably erasing.

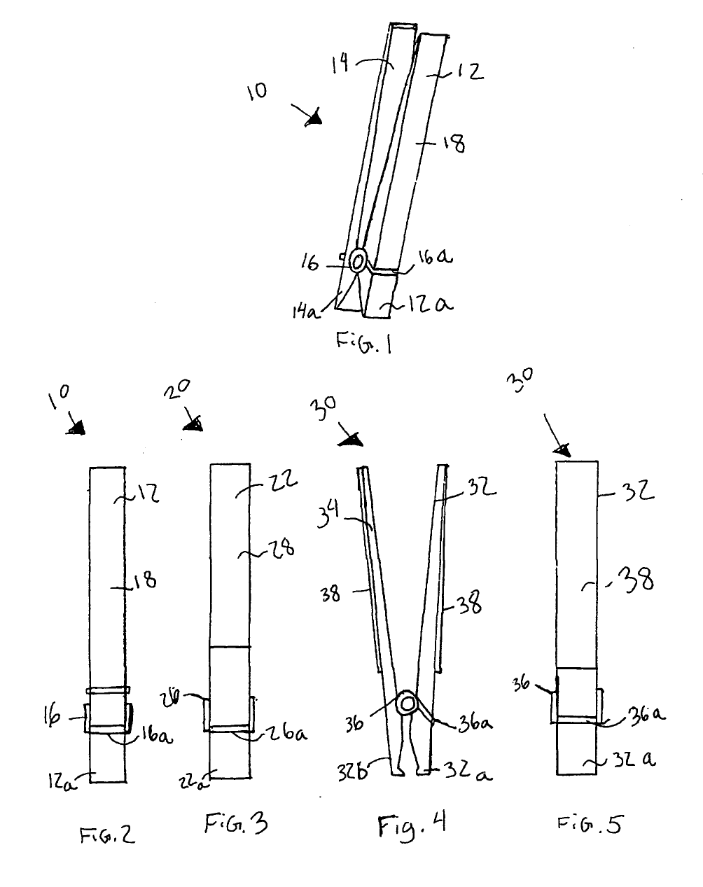

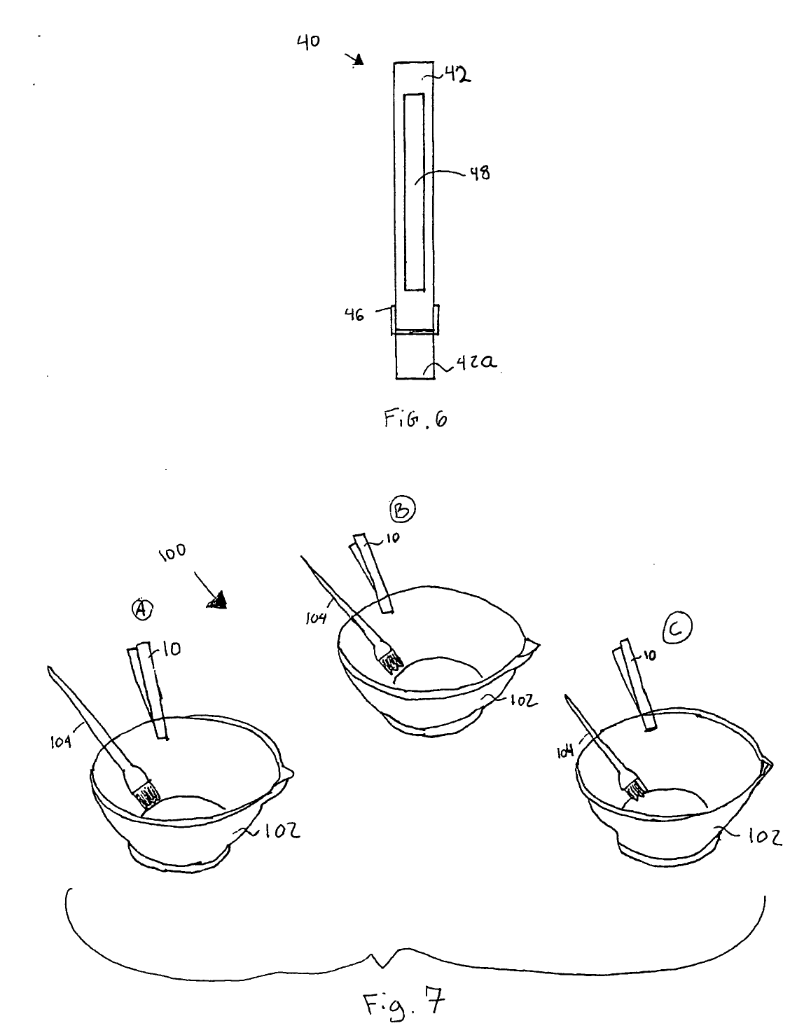

Another further embodiment of the hair coloring identification clip device 30 is shown in FIGS. 4 and 5.

The hair coloring identification clip device 30 is provided a separate marking or writing surface 38 (e.g. texture surface) applied to one or both clip portions 32, 34. The textured surface 38, for example, can be as laminate, textured laminate, film, textured film, textured plate, plastic laminate, polymer laminate, paper laminate, cardboard laminate, plastic laminate, label, sticker, or other suitable surface applied by adhering, heat welding, insert plastic injection molding, or other suitable technique. The surface 32 is markable or writable, and preferably is also erasable.

An even further embodiment of the hair coloring identification clip device 40 is shown in FIG. 6.

The hair coloring identification clip 40 includes a writing surface label portion 48 configured to be wider versus the width of the clip portions 42, 44. The wider writing surface label portion 48 can be integral with one or both of the clip portions 42, 44, or can be a separate writing surface label portion 48 applied to one or more of the clip portions 42, 44. The increased width of the writing surface label portion 48 allows for more room for a user to write a particular hair color formula thereon. A hair colorist can mark or write on the surface of the writing surface label portion 48, or one or more labels (e.g. sticky back blank labels that can be written on) can be attached to the writing surface label portion.

A hair coloring identification system 100 according to the present invention is shown in FIG. 7.

The hair coloring identification system 100 includes multiple containers or bowls 102 each provided with a hair coloring brush applicator and hair coloring identification clip device 10 for identifying the particular hair coloring formula contained in each of the containers or bowls 102. It is noted that the system 100 can include two containers 102 or four or more containers depending on the particular hair coloring application.

I claim:

1. A hair coloring formula identification clip, comprising:
a smooth, hard plastic, dark colored, specifically contoured gripping notched end first clip portion;
a smooth, hard plastic, dark colored, specifically contoured gripping notched end second clip portion connected to said first clip portion;
a spring connected to both of said first clip portion and said second clip portion, said spring configured for releasably biasing gripping end portions of said first clip portion and said second clip portion together—said spring is specifically developed in such a manner to allow space for a customized label on both said first clip portion and said second clip portion; and
a stain and water resistant, peel and stick, replaceable wet erase writing surface label portion provided on at least one both of said first clip portion and said second clip portion, said writing surface portion including a writable and erasable surface specifically configured to allow a user to write with a wet erase pen and then erase the writing to allow reuse thereof,
whereby a user writes a hair coloring formula on said writing surface portion of the first clip portion, and writes the formula placement on said writing surface portion of the second clip portion, and then clips said hair coloring formula clip onto any universal or standard container to identify the particular hair coloring formula contained or to be contained therein, as well as it's placement.

2. A device according to claim 1, wherein both of said first clip portion and said second clip portion are provided with a stain and water resistant, peel and stick, replaceable wet erasable surface portion.

3. A device according to claim 2, wherein both said first clip portion and said second clip portion are provided with stain and water resistant, peel and stick, replaceable wet erasable surface portions.

4. A device according to claim 1, wherein both of said first clip portion and said second clip portion are provided with a widened area to provide space for a wet erase label portion having a stain and water resistant, peel and stick, replaceable wet erasable surface.

5. A device according to claim 1, wherein said wet erase label portion is integral with both of said first clip portion and said second clip portion.

6. A device according to claim 1, Wherein said wet erase label portion is a separate part and adhered to both of said first clip portion and said second clip portion.

7. A device according to claim 6, wherein said wet erase label portion is a stain and water resistant, peel and stick, replaceable wet erasable surface adhered to both of said first clip portion and said second clip portion.

8. A device according to claim 1, wherein said writable and erasable custom sized surface portion is a polymer film having an erasable surface on one side and adhered to both of said first clip portion and said second clip portion on the opposite side of said polymer film.

9. A device according to claim 1, wherein said wet erase label portion is plastic injection molded with said first clip portion and said second clip portion.

10. A device according to claim 1, wherein both of said first clip portion and said second clip portion are dark colored, smooth, hard plastic injection molded, and said wet erase label portion is textured to provide an erasable surface portion on both of said first clip portion and said second clip portion.

11. A hair coloring formula identification system, comprising:
a plurality of hair coloring formula identification clip devices, said clip devices each including a writable and erasable surface portion;
a plurality of all universal or standard containers for containing different hair coloring formulas,
whereby a user fills said plurality of universal or standard containers with different hair coloring formulas, identifies the particular hair coloring formulas in each said containers by writing the particular hair coloring formulas on said first clip portion, and identifying the particular hair coloring placement on said second clip portion and attaching said identification clips to said containers containing the corresponding hair coloring formulas and their placement.

12. A device according to claim 1, wherein said containers are any universal or standard salon mixing bowls.

13. A method of identifying hair coloring formulas, including the steps of:
Determine color formula combination;
Write individual formulation on said first clip portion wet erasable label and the placement of the formula on said second clip portion (each application may require multiple formulas—one clip per formula);
apply hair coloring formula identification clip devices to an empty said containers to identify the particular hair coloring formula contained in each said containers; and
mix formula ingredients noted on individual clips now attached to the plurality of containers.

14. A method according to claim 14, wherein said hair coloring identification clip devices have writable and erasable surface portions.

15. A method according to claim 15, wherein said hair coloring identification clips have erasable wet erase label portions, and erasing said wet erase label portions after use to allow reuse thereof.
